(19) United States
(12) Patent Application Publication
(10) Pub. No.: US 2015/0058762 A1
(43) Pub. Date: Feb. 26, 2015

(54) INTERFACE DEVICE, INTERFACE METHOD, INTERFACE PROGRAM, AND COMPUTER-READABLE RECORDING MEDIUM STORING THE PROGRAM

(71) Applicant: Sharp Kabushiki Kaisha, Osaka (JP)

(72) Inventor: Koji SATO, Osaka-shi (JP)

(21) Appl. No.: 14/450,409

(22) Filed: Aug. 4, 2014

(30) Foreign Application Priority Data
Aug. 23, 2013 (JP) 2013-173325

(51) Int. Cl. G06F 3/0484; G06F 3/0481

(52) U.S. Cl. CPC G06F 3/04845; G06F 3/04817
USPC 715/763

(57) ABSTRACT

An interface device includes a display unit that displays icons, a rotating unit that orders changes in orientations of the icons, and an executing unit that orders execution of applications corresponding to the icons. The display unit changes and displays the orientations of the icons in response to the icon orientation change order issued by the rotating unit, and also displays, upon accepting that the executing unit has specified an icon and ordered execution of an application, a window with an orientation that coincides with the orientation of the icon, such that users located around the display screen view icons and windows in orientations that are easily comprehensible to each user.

### BACKGROUND OF THE INVENTION

1. Field of the Invention

The present invention relates to a graphical user interface device used in computers or the like and particularly to an interface device which is equipped with a display screen that can be disposed horizontally and which is suitable for screen operations from four surrounding directions, as well as an interface method, an interface program, and a computer-readable recording medium storing the program.

2. Description of the Related Art

Smartphones, tablets, and other portable-type information processing devices have become widespread in recent years. A display on the image display surface of which a touch panel is disposed (hereinafter referred to as “touch panel display”) is used as such a user interface device. Users can manipulate objects displayed on the touch panel display by direct touch.

Because of this, computers have also come to be installed with touch panel displays, and touch operations to be adopted in place of conventional computer keyboards (hereinafter referred to simply as “keyboards”) and computer mice (hereinafter referred to simply as “mice”). Operating systems (hereinafter referred to as “OS”) which employ user interfaces that envision touch operations are also available.

As the screens of touch panel displays become progressively larger, touch panel displays are expected to find use in a variety of applications in the future. For example, their use has been proposed not just in obvious applications such as electronic blackboards, but also as image display surfaces that are horizontally disposed as tables where touch operations can be used (such as business or conference tables).

As this sort of touch-operable image display device becomes more common, improvements will be required in user interfaces. For instance, in Japanese Patent Application Laid-Open Publication No. 2000-305693, a technology is disclosed for resolving the problem that, when a display unit is rotated 180° from the closed position to the open position relative to the main body unit of a notebook-style personal computer in order to show the image information displayed on a liquid crystal panel to a person other than the user, the image information appears upside down to the other person, worsening legibility.

The notebook-style personal computer disclosed in Japanese Patent Application Laid-Open Publication No. 2000-305693 is equipped with a touchpad for operating a cursor. When an application program starts up and a corresponding window is displayed, a display rotation program starts up. Three types of individual display orientation-specifying buttons are installed within each window that is displayed to indicate the display orientations for rotating this window using arrow marks. When an individual display orientation-specifying button is clicked using the touchpad, this window rotates to the specified orientation with the intersection of the diagonal lines of this window being used as the center. Japanese Patent Application Laid-Open Publication No. 2000-305693 also discloses the display, in the bottom right corner of the screen, of a batch display orientation-specifying button for changing the orientations of a plurality of windows that are displayed at once and a free rotation-specifying button for rotating a selected window to any degree of rotation.

### SUMMARY OF THE INVENTION

There still remains the issue, however, of improving operability of touch panel displays on large screens. In particular, problems can arise when a touch panel display for a large screen is designed with a specific orientation of the screen as the standard orientation in an interface device that uses an image display surface disposed horizontally as a table (hereinafter also referred to as a “table-style interface device”). Although this is not limited to table-style interface devices, normally, when the center of the display screen is viewed from one particular side of the four sides of the display screen, the orientation in which the displayed image can be seen as an upright image (the orientation facing from the particular side to the center of the screen) is set up as the standard orientation.

When a table-style interface device is shared by a plurality of users and work is performed jointly by manipulating icons that represent content (files) and shortcuts disposed on the screen while running a variety of application programs (hereinafter also referred to simply as “applications”), images of components (icons, windows, and the like) displayed on the screen are viewed as upright images by viewing users whose orientation is the same as the standard orientation (users near the particular side). Users near the other three sides will be viewing the component images sideways or upside down, so they may not be able to easily comprehend the component images. Information that identifies the corresponding content (for example, filenames) is displayed on icons using text. This text information may be particularly difficult to read for users viewing from the three orientations other than the standard orientation.

This problem can occur not just in table-style interface devices, but also in notebook-style computers, tablet-style computers, and the like that can be disposed with the display unit substantially horizontal.

A window becomes viewable as an upright image from orientations other than the standard orientation by using the technology that rotates displayed windows disclosed in Patent Document 1. However, the problem of icons being difficult to comprehend from orientations other than the standard orientation of the screen cannot be solved by the technology disclosed in Japanese Patent Application Laid-Open Publication No. 2000-305693, either. Furthermore, there is a problem in that the user must operate to rotate windows that have already been displayed along the standard orientation, which is bothersome.

Accordingly, preferred embodiments of the present invention provide an interface device, interface method, and interface program that make component images displayed on a screen easy to comprehend for users who view the screen from orientations other than the standard orientation in devices equipped with display screens that can be disposed horizontally, as well as a computer-readable recording medium storing the program.

An interface device according to a preferred embodiment of the present invention includes a display device configured to display icons on a screen; and a processor configured and programmed to define a rotating unit configured to order changes in orientations of the icons; an executing unit configured to select at least one of the icons and order execution of an application program; a changing and displaying unit configured to change the orientations of the icons and display the changed orientations of the icons in response to the rotating unit ordering the changes in the orientations of the icons; and a displaying unit configured to, upon accepting that the executing unit has selected the at least one of the icons and ordered execution of the application program, display a window such that an orientation of the window coincides with the orientation of the at least one of the icons.

The interface device preferably further includes a storage device configured to store phase information that indicates the orientations of the icons relative to a standard orientation set for the screen, the storage device being configured to change the phase information of the icons in response to the rotating unit ordering the changes in the orientations of the icons, and upon accepting that the executing unit has selected the at least one of the icons and ordered execution of the application program, the display device displays the window in an orientation determined by the phase information of the at least one of the icons.

More preferably, the rotating unit is configured to change, for each of the icons, the orientation of the respective icon to an arbitrary orientation.

Even more preferably, the orientation of each of the icons is any of four orientations that face four sides of the screen from a center of the respective icon.

Preferably, the display device, upon accepting that the executing unit has selected a plurality of the icons and ordered execution of a plurality of the application programs, displays corresponding windows such that the orientations of the windows coincide with the respective orientations of the selected icons.

An interface method according to another preferred embodiment of the present invention includes the steps of displaying icons on a screen; ordering changes in orientations of the icons; selecting at least one of the icons; ordering execution of an application program; changing the orientations and displaying the changes in the orientations of the icons in response to the step of ordering changes in orientations of the icons; and after the steps of selecting at least one of the icons and ordering execution of an application program, displaying a window such that an orientation of the window coincides with the orientation of the at least one of the icons selected in the step of selecting at least one of the icons.

According to yet another preferred embodiment of the present invention, a non-transitory computer-readable medium includes a computer program for having a computer equipped with a display device perform, when the computer program runs on the computer, a method including the steps of displaying icons on a screen of the display device; ordering changes in orientations of the icons; selecting at least one of the icons; ordering execution of an application program; changing the orientations and displaying the changes in the orientations of the icons in response to the step of ordering changes in orientations of the icons; and after the steps of selecting at least one of the icons and ordering execution of an application program, displaying a window such that an orientation of the window coincides with the orientation of the at least one of the icons selected in the step of selecting at least one of the icons.

In a table-style interface device or other such devices equipped with a display surface that is capable of being disposed horizontally, preferred embodiments of the present invention make it possible for users located around the display screen to display icons and windows in orientations suited to each of the users. Therefore, it is possible to increase the efficiency of work performed jointly using a single display screen.

Moreover, in examples where a plurality of icons oriented in different directions are selected and execution of applications is ordered, the corresponding windows are displayed in orientations that are the same as the orientations of the respective icons. Therefore, as long as icons are displayed in orientations suitable for individual users viewing the display screen from different directions, the respective windows are displayed at once in orientations that are easily comprehensible by each user.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a block diagram schematically showing a configuration of the interface device according to a first preferred embodiment of the present invention.

FIG. 2 is a diagram showing one example of a touch input detection method.

FIG. 3 is a flowchart showing the control structure of a program for facilitating users located around the display screen to comprehend component images.

FIG. 4 is a plan view showing the display screen of the display unit of the interface device.

FIG. 5 is a plan view showing the display screen in a state in which a menu used to select an order involving an icon is displayed.

FIG. 6 is a diagram showing the structure of an icon database.

FIG. 7 is a diagram showing a relationship between an icon and the coordinate axes.

FIG. 8 is a plan view showing the display screen in a state in which a shortcut has been added from the state shown in FIG. 4.

FIG. 9 is a diagram showing an icon database that contains information pertaining to the icon shown in FIG. 8.

FIG. 10 is a plan view showing the display screen in a state in which a menu used to select the icon rotation angle is displayed.

FIG. 11 is a plan view showing the display screen in a state in which the shortcut icon has been rotated from the state shown in FIG. 8.

FIG. 12 is a diagram showing an icon database that contains information pertaining to the icon shown in FIG. 11.

FIG. 13 is a flowchart showing the application processing of FIG. 3.

FIG. 14 is a diagram showing a state in which a menu used to select an order involving the rotated icon is displayed.

FIG. 15 is a plan view showing the display screen in a state in which four icons are displayed.

FIG. 16 is a diagram showing an icon database that contains information pertaining to the icons shown in FIG. 15.

FIG. 17 is a plan view showing the display surface in a state in which an executing order is issued to one of the icons and the corresponding window is displayed.

FIG. 18 is a plan view showing the display surface in a state in which an executing order is issued to one of the icons and the corresponding window is displayed.

FIG. 19 is a plan view showing the display surface in a state in which an executing order is issued to one of the icons and the corresponding window is displayed.

FIG. 20 is a plan view showing the display surface in a state in which an executing order is issued to one of the icons and the corresponding window is displayed.

FIG. 21 is a block diagram showing the functional modules in the interface device according to a second preferred embodiment of the present invention.

FIG. 22 is a flowchart showing the control structure of the program that is executed in the interface device according to a third preferred embodiment of the present invention.

FIG. 23 is a flowchart showing the rotation processing in FIG. 22.

FIG. 24 is a diagram showing icon rotation processing.

### DETAILED DESCRIPTION OF THE PREFERRED EMBODIMENTS

In the following description of preferred embodiments of the present invention, the same reference numbers are assigned to the same components. The names and functions thereof are also the same. Therefore, a detailed description thereof will not be repeated.

In the following, “touch” will refer to a state in which an input position detection device detects a position, and includes cases when the detection device is contacted and pressed, when it is contacted without being pressed, and when it is approached without being contacted. Detection devices for input positions are not limited to contact-style devices and may also include non-contact devices. “Touch” in the case of a non-contact detection device refers to a state of approaching the detection device close enough that the input position is detected.

### First Preferred Embodiment

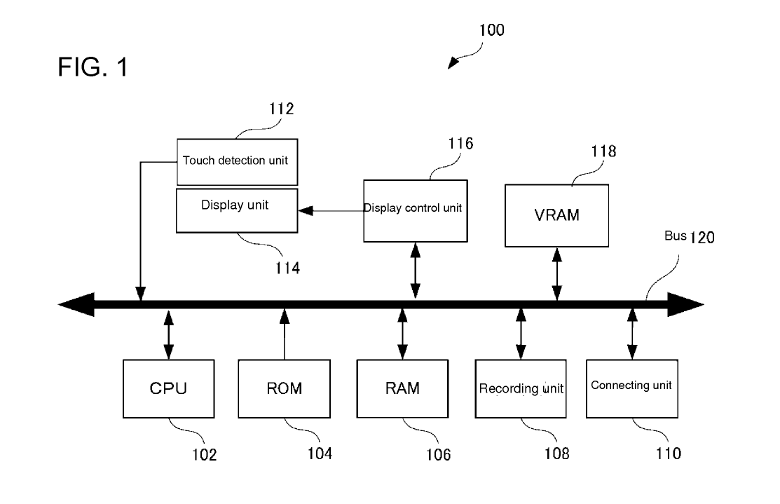

With reference to FIG. 1, the interface device 100 according to a first preferred embodiment of the present invention includes an operation processing unit (hereinafter referred to as “CPU”) 102, a read-only memory (hereinafter referred to as “ROM”) 104, a rewritable memory (hereinafter referred to as “RAM”) 106, a recording unit 108, a connecting unit 110, a touch detection unit 112, a display unit 114, a display control unit 116, a video memory (hereinafter referred to as “VRAM”) 118, and a bus 120. The CPU 102 is programmed to control the entire interface device 100.

The interface device 100 preferably is a table-style interface device. Specifically, as will be described below, the touch detection unit 112 and the display unit 114 constitute a touch panel display, and the image display surface of the touch panel display preferably is disposed horizontally, such that the interface device 100 is used as a table.

The ROM 104 is a non-volatile storage device and is configured to store programs and data required to control the operation of the interface device 100. The RAM 106 is a volatile storage device from which data is erased when power is shut off. The recording unit 108 is a non-volatile storage device that holds data even when power is shut off; for example, it is a hard disk drive, flash memory, or the like. The recording unit 108 may also be configured so as to be removable. The CPU 102 reads a program from the ROM 104 via the bus 120 into the RAM 106 and then executes the program using a portion of the RAM 106 as a working area. The CPU 102 is configured to control the various components of the interface device 100 in accordance with programs stored in the ROM 104.

The bus 120 connects the CPU 102, the ROM 104, the RAM 106, the recording unit 108, the connecting unit 110, the touch detection unit 112, the display control unit 116, and the VRAM 118. The exchange of data (including control information) between units is performed via the bus 120.

The connecting unit 110 is an interface that connects with external devices. For instance, it is an interface with a keyboard, mouse, or the like. Furthermore, the connecting unit 110 may also include a network interface card (NIC) configured to connect the interface device 100 with a network.

The display unit 114 is a display panel (such as a liquid crystal panel, for example) configured to display images. The display control unit 116 is equipped with a drive unit configured to drive the display unit 114, reads image data stored in the VRAM 118 at prescribed timings, generates a signal to display the data as an image on the display unit 114, and outputs the signal to the display unit 114. The CPU 102 reads the image data to be displayed from the recording unit 108 and sends it to the VRAM 118.

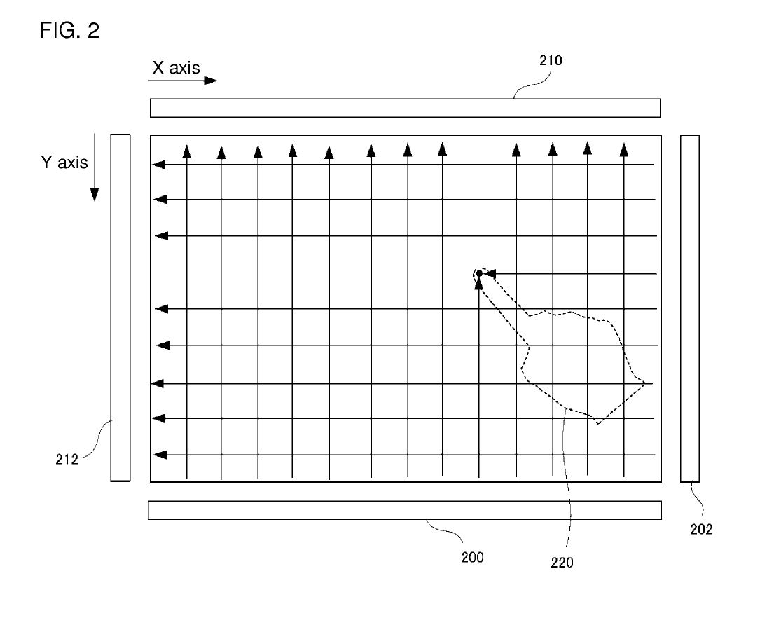

The touch detection unit 112 is a touch panel and is configured to detect touch operations performed by users. The touch detection unit 112 is preferably laminated onto the display screen of the display unit 114. Touches made on the touch detection unit 112 are operations that specify the points on the image displayed on the display screen that correspond to the touched positions. Accordingly, in the present description, in order to eliminate redundant descriptions, when the description involves the touch of an image displayed on the display unit 114, the description will refer to a touch of the corresponding position on the touch detection unit 112. The detection of touch operations when a touch panel is used as the touch detection unit 112 will be described with reference to FIG. 2.

FIG. 2 shows a touch panel (touch detection unit 112) that uses infrared ray interception detection, for example. The touch panel preferably includes light-emitting diode columns (hereinafter noted as “LED columns”) 200 and 202 disposed in one column on each of two adjacent sides of a rectangular or substantially rectangular writing input surface and two photodiode columns (hereinafter noted as “PD columns”) 210 and 212 each disposed in one column so as to face the respective LED columns 200 and 202. Infrared rays are emitted from the individual LEDs in the LED columns 200 and 202, and the infrared rays are detected by the respective PDs in the facing PD columns 210 and 212. In FIG. 2, the infrared rays from the individual LEDs in the LED columns 200 and 202 are indicated by arrows facing upward and leftward.

The touch panel preferably includes a microcomputer (for example, an element that includes a CPU, memory, input/output circuitry, and the like), for example, and controls the light emission of each of the LEDs. The individual PDs output voltages in keeping with the intensity of the light received. The PD output voltages are amplified by amps. Moreover, signals are output simultaneously from the plurality of PDs of each of the PD columns 210 and 212, so the output signals are temporarily stored in a buffer, then output as serial signals according to the PD array sequence, and transferred to the microcomputer. The sequence of the serial signals output from the PD column 210 expresses the X coordinates. The sequence of the serial signals output from the PD column 212 expresses the Y coordinates.

When the user (shown by the broken line in FIG. 2) 220 touches the touch panel with a finger, infrared rays are intercepted at the touched position. Accordingly, the output voltages of the PDs that received these infrared rays prior to their being intercepted decrease. Because the signal portions from the PDs that correspond to the touched position (XY coordinates) decrease, the microcomputer detects the portion of the two serial signals received whose signal level has decreased and finds the coordinates of the touched position. The microcomputer sends the position coordinates that it has determined to the CPU 102. This processing to detect the touched position is repeated in a prescribed detection cycle, so if the same point is touched for a period of time longer than the detection cycle, the same coordinate data is output repeatedly. If no point is being touched, the microcomputer does not send position coordinates.

The technology that detects touched positions described above is publicly known, so the description will not be repeated any further. In addition, touch panels of systems other than infrared ray interception (capacitive systems, surface acoustic wave systems, resistive film systems, etc.) may be used for the touch detection unit 112. Note that, with the capacitive system, positions are detected even without contact by moving close to the sensor.

The interface device 100 preferably is configured as described above. The user can operate the interface device 100 in the same manner as a computer. The user can start applications with a touch operation of the user interface (images of components such as operating buttons and icons) on the screen displayed on the display unit 114 via the touch detection unit 112 and can perform via the touch detection unit 112 operations within the windows that are displayed by the started application. A description will be given of processing that is used in such a state to facilitate individual users comprehending component images (icons, windows, and the like) when a plurality of users surrounding the touch panel display manipulate the component images.

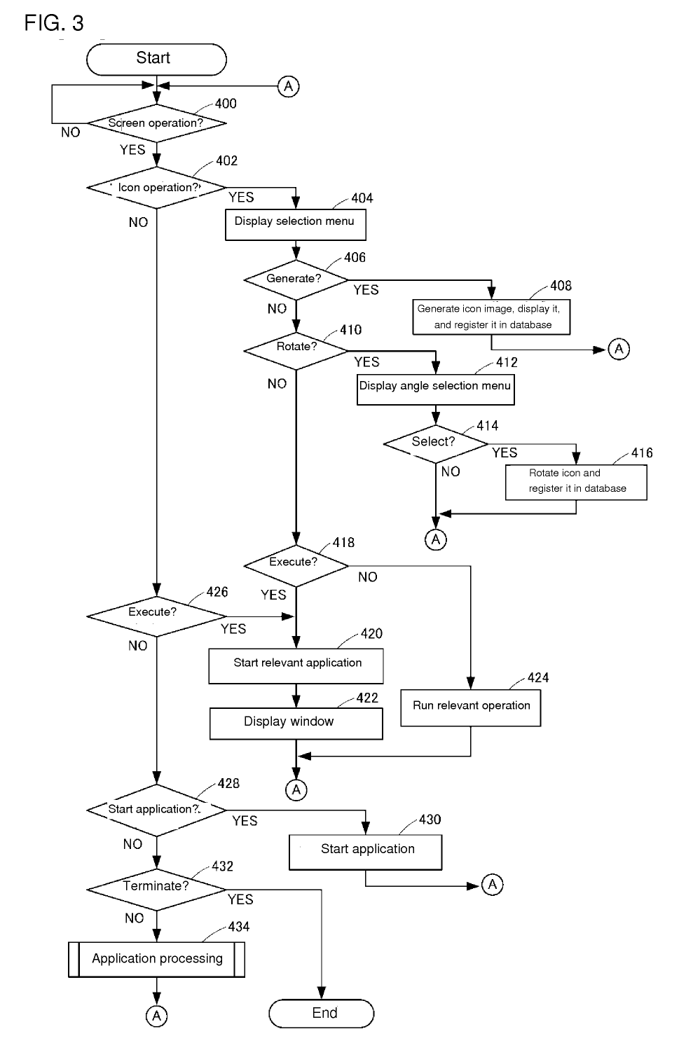

This processing is realized by the program shown in FIG. 3. Specifically, in the interface device 100, programs for making it easier for each user located around the touch panel display to comprehend component images are read from the ROM 104, for example, and executed after the OS starts up when power to the interface device 100 is turned on.

After the initialization required for this program to be executed is completed, the CPU 102 determines in step 400 whether or not a “screen operation” has occurred. In concrete terms, the CPU 102 determines whether or not the touch detection unit 112 has been touched and this touch operation is an operation that corresponds to a screen operation. The CPU 102 determines whether or not position coordinates have been received from the touch detection unit 112 as described above. The touch detection unit 112 does not output position coordinates if it was not touched; if it was touched, the touch detection unit 112 outputs the position coordinates (X coordinate, Y coordinate) of the point that was touched.

Here, “screen operation” refers to an operation that issues some kind of order to the interface device 100 as a result of a touch operation involving the touch panel display. For example, when the position that was touched is on a component image that represents an object of operations such as a button or an icon, this touch operation is deemed a screen operation. For instance, a touch operation involving an icon (a single touch of short duration) represents an operation that selects the icon. Furthermore, even if the touched position is a position not on a component image, if a touch operation is nonetheless a special touch operation to which an instruction to the interface device 100 is assigned (for example, a hold-down operation that maintains a touch for at least a prescribed period of time on the same position), then it is deemed a screen operation. For instance, while a touch to the background region where no component image is displayed is not a screen operation, a hold-down operation has an instruction to display a menu assigned thereto, so it is deemed a screen operation. Note that when a special touch operation is performed on a component image, it naturally is deemed a screen operation. When an operation is deemed to be a screen operation, control shifts to step 402. If not, step 400 is repeated.

In step 402, the CPU 102 determines whether or not the operation is an “icon operation.” “Icon operation” refers to an operation involving an icon itself. In concrete terms, the CPU 102 determines that an operation is an icon operation when the position coordinates received in step 400 (touched position coordinates) are located on an icon and the touch operation is a hold-down operation. If an operation is a tap or double tap (two consecutive touches within a short period of time), it is deemed not to be an icon operation even if the touched position is located on an icon. When an operation is deemed to be an icon operation, control shifts to step 404. If not, control shifts to step 426.

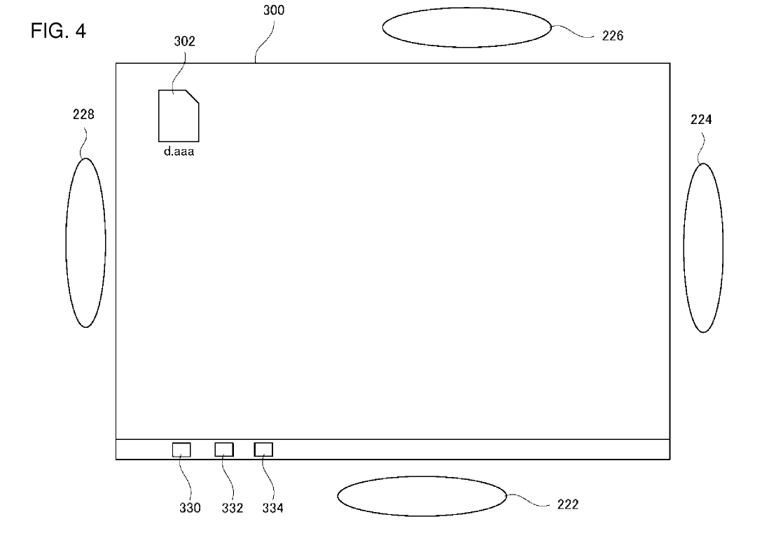

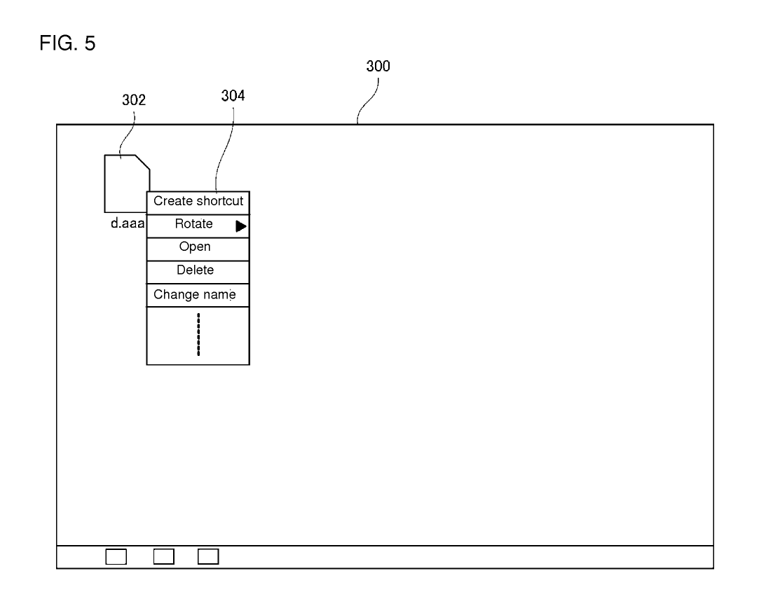

In step 404, the CPU 102 displays a prescribed menu in keeping with the orientation of the touched icon and waits for a user operation. For example, in a situation where an icon 302 is displayed on the display screen 300 of the display unit 114, and there are four users 222 to 228 around the display screen 300 as shown in FIG. 4, if one of the users performs a hold-down operation on the icon 302, then a menu 304 is displayed with the same orientation as the icon 302 near the touched position as shown in FIG. 5. If there is a subsequent touch operation, control shifts to step 406.

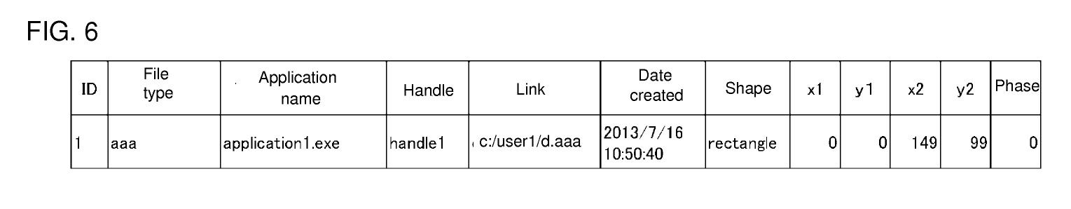

Information pertaining to the icons displayed on the display unit 114 is stored in the recording unit 108 as a database (hereinafter referred to as “icon database”). In the figures, a database is abbreviated as DB. The icon database is stored in the recording unit 108 with a correspondence being made to an ID (here, “1”) to identify the icon 302 as shown in FIG. 6, for example. Information pertaining to icons includes icon IDs, the file type (extension) that the icon represents, the name of the application that created this file (executing program name), handles, links that express file locations, creation dates of icons (time, day, month, and year), icon shapes, icon display positions and sizes, and icon phases. The icon 302 shown in FIG. 4 is displayed according to the information of FIG. 6. Note that the icon database shown in FIG. 6 mainly indicates information required by the function that rotates the icon orientation; icon image information (icon images for each application and text displayed along with the icon image) and the like is stored in the recording unit 108 linked to icon IDs, for example.

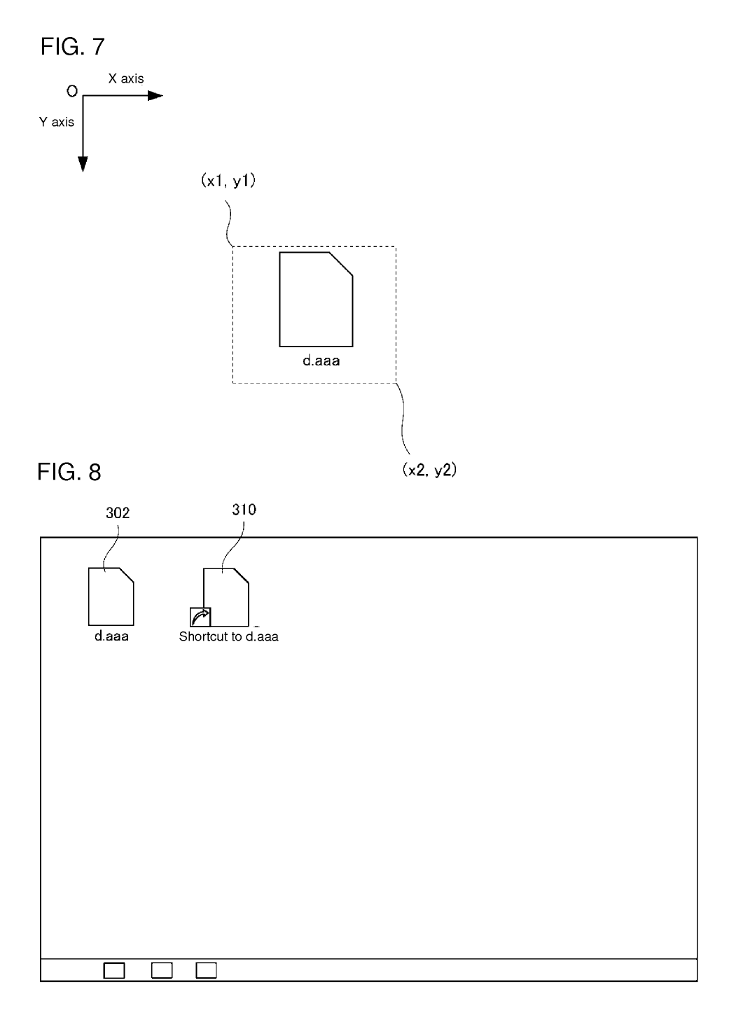

The icon shape refers to the shape of the region bounded by the dotted line in FIG. 7, for example, being the region that includes the icon image and text image (hereinafter also referred to as the “icon area”), and the word “rectangle” refers to a rectangle. Moreover, as shown in FIG. 7, the direction to the right (toward the user 224) and the direction to the bottom (toward the user 222) of the display screen 300 (FIG. 4) are respectively set as the positive directions of the X axis and Y axis, and the display position and size of the icon area are expressed by the coordinates of the top left position (x1, y1) and the coordinates of the bottom right position (x2, y2) of the rectangular icon area. The negative direction on the Y-axis is the standard orientation of the display screen 300. Based on (x1, y1) and (x2, y2), the CPU 102 can determine whether or not a touched position is within the icon area. In FIG. 6, the size of the icon whose ID is 1 is 150 pixels in the X-axis direction and 100 pixels in the Y-axis direction.

“Icon phase” refers to information that expresses the upright orientation of the icon image (hereinafter also referred to as the “icon orientation”); it is the angle formed by the upright orientation of the icon image displayed in the display unit 114 and the standard orientation (the negative direction of the Y-axis), which is the angle in the clockwise rotational direction. The upright orientation of the component image (icon image, window image, etc.) is the direction that faces from the bottom to the top of a component image that can be seen not upside down but upright, which is also the direction facing from the bottom to the top of the text that is displayed. Here, the icon phase is set to the discrete value of “0,” “90,” “180,” or “270,” which represents the icon orientation being the standard orientation (the negative direction of the Y-axis, i.e., upward on the screen 300), the positive direction of the X-axis (rightward on the screen 300), the positive direction of the Y-axis (downward on the screen 300), or the negative direction of the X-axis (leftward on the screen 300), respectively. For example, the icon 302 (icon image) in FIG. 4 is upright when viewed by the user 222, so the upright orientation of this icon image coincides with the standard orientation.

The CPU 102 displays the menu 304 (FIG. 5) in the icon orientation based on the icon phase (0° in FIG. 6). That is, the menu 304 is displayed such that the upright orientation of the text image of the menu 304 coincides with the icon orientation.

Handles are set with a one-to-one correspondence to the content (files). For example, a plurality of shortcut icons can be created for a single file, and in such cases, a different ID can be given to each shortcut icon and different data registered in the icon database. However, the same data that identifies the same single file is set in the handle. It is a publicly known technique to use handles to maintain consistency in file operations across multi-window environments.

In step 406, the CPU 102 determines whether or not an instruction to generate an icon was selected off the menu displayed in step 404. In concrete terms, it determines whether or not “Create shortcut” on the menu 304 displayed in FIG. 5 was touched. If it is determined that “Create shortcut” was touched, control shifts to step 408. If not, control shifts to step 410.

In step 408, the CPU 102 generates a shortcut icon for the touched icon, displays it on the display unit 114 in the prescribed orientation, and stores information pertaining to the generated icon in the icon database of the recording unit 108. Thereafter, control returns to step 400.

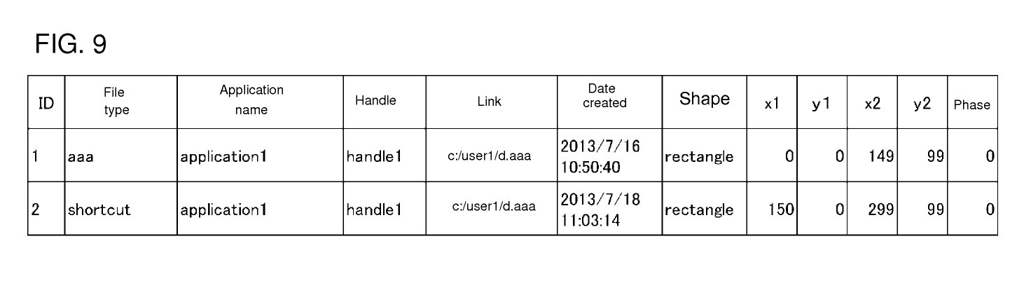

A shortcut icon 310 is displayed, for example, such that the orientation thereof (the upright orientation of the icon image) becomes the standard orientation as shown in FIG. 8. In the image of the shortcut icon 310, the images of an arrow and the text of “Shortcut to . . . ” are added to the image of the icon 302, which represents the file. Information pertaining to the shortcut icon 310 is stored in the icon database of the recording unit 108 linked to an ID of 2 as shown in FIG. 9. For the file type, “shortcut” is stored, which indicates that it is a shortcut to content rather than the content itself.

In step 410, the CPU 102 determines whether or not an instruction to rotate an icon orientation was selected off the menu displayed in step 404. In concrete terms, it determines whether or not “Rotate” on the menu 304 shown in FIG. 5 was touched. If “Rotate” is deemed to have been touched, control shifts to step 412. If not, control shifts to step 418.

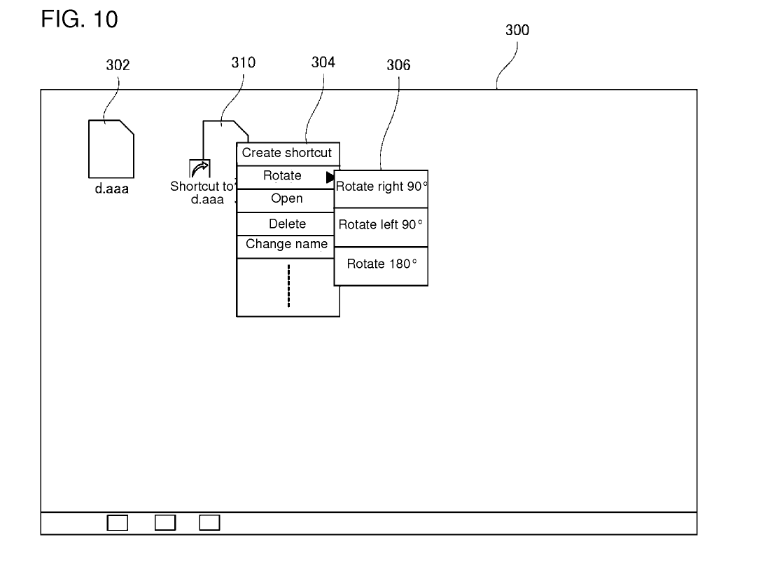

In step 412, the CPU 102 displays an angle selection menu. In concrete terms, the CPU 102 displays an angle selection menu 306 which includes items for three types of rotation direction to the right of the “Rotate” item as shown in FIG. 10. The triangle shown at the right end of the “Rotate” item indicates that there is a submenu. FIG. 10 shows a state in which the menu 304 is displayed as a result of a hold-down operation on the shortcut icon 310, and the angle selection menu 306 is displayed as a result of “Rotate” being touched.

In step 414, the CPU 102 determines whether or not an item on the rotation direction menu was selected. If it is determined that one of the rotation direction menu items was selected, then control shifts to step 416. If not, i.e., if it is determined that an area other than the rotation direction menu was touched, then the operation is deemed canceled, and control returns to step 400.

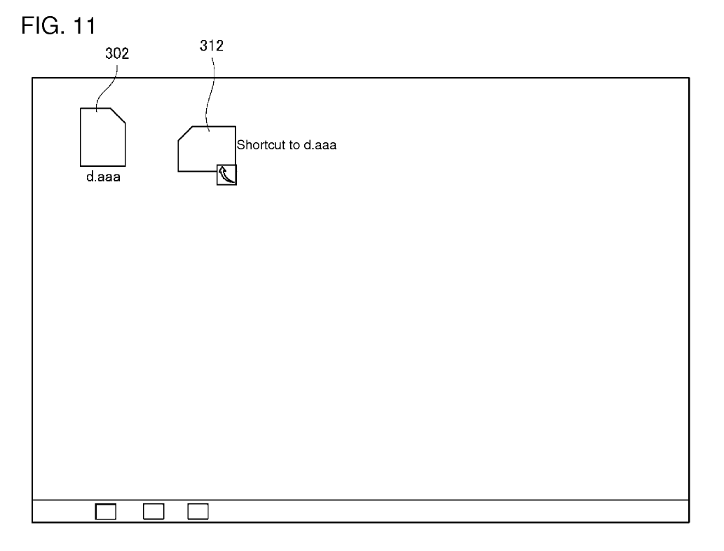

In step 416, the CPU 102 rotates the icon orientation and displays it on the display unit 114 in accordance with the item selected in step 414, and the information of the corresponding icon is changed in the information stored in the icon database of the recording unit 108. In concrete terms, the phase of the icon newly set by the specified rotation is obtained by rotating the pre-rotation icon phase in the clockwise direction by the number of degrees corresponding to the item. For example, if “Rotate” (see FIG. 10) is touched on the menu that is displayed as a result of a hold-down operation being performed on the shortcut icon 310 shown in FIG. 8, and “Rotate left 90°” is touched on the menu displayed, then a shortcut icon 312 is displayed as shown in FIG. 11. The shortcut icon 312 is the shortcut icon 310 shown in FIG. 8 rotated counterclockwise by 90° (i.e., clockwise by 270°). Note that the position coordinates of the point at the top left of the icon area are maintained before and after rotation.

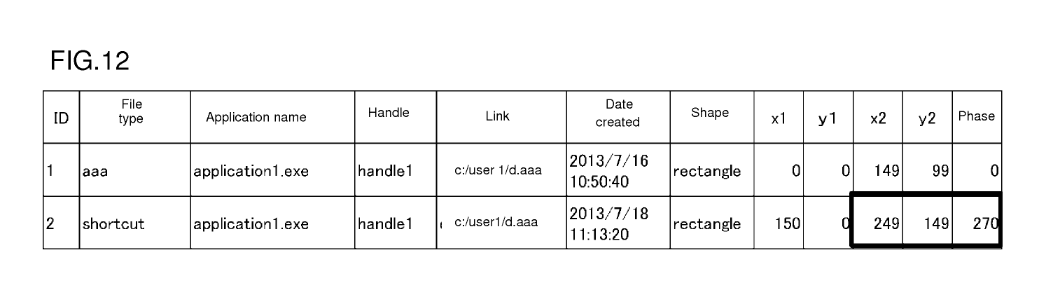

The information linked to the ID of 2 that identifies the shortcut icon 310, which was the object of rotation processing, is changed in the icon database of the recording unit 108 as shown in FIG. 12 according to the post-rotation shortcut icon 312. In concrete terms, the icon phase and (x2, y2) are changed according to the rotation instruction. In FIG. 12, the icon phase is changed from “0” to “270.” Because the position coordinates of the point at the top left of the icon area are maintained before and after rotation as described above, no change is made to (x1, y1). If the shape of the icon to be rotated is rectangular, (x2, y2) is changed. The shape of the shortcut icon 310 (the shape of the icon area) shown in FIG. 9 is a rectangle of 150 pixels in the X-axis direction and 100 pixels in the Y-axis direction. The post-rotation shortcut icon 312 of FIG. 12 is 100 pixels in the X-axis direction and 150 pixels in the Y-axis direction, so the position coordinates (x2, y2) of the point at the lower right of the shortcut icon 312 are changed to (249, 149). If the shape of the icon is square, there is no change in (x2, y2) before and after rotation.

In step 418, the CPU 102 determines whether or not an item that executes an icon was selected off the menu 304 displayed in step 404. In concrete terms, it determines whether or not “Open” on the menu shown in FIG. 5 was touched. If it determines that “Open” was touched, control shifts to step 420. If not, control shifts to step 424.

In step 420, the CPU 102 points out the relevant file and starts the corresponding application. In concrete terms, the CPU 102 reads the application name and link information in the information pertaining to the icon identified in step 402 (icon ID) from the icon-related information stored in the icon database of the recording unit 108, then starts the corresponding application, and transfers the link information to the started application. In concrete terms, the CPU 102 starts the “application1.exe” of FIG. 6 and generates a window image based on the link information “c:/user/d.aaa.”

In step 422, the CPU 102 reads the icon phase that corresponds to the icon selected in step 402 from the icon database of the recording unit 108 and displays on the display unit 114 a window generated by the started application such that the upright orientation of the window matches the icon phase. That is, the window is displayed such that the upright orientation of the icon coincides with the upright orientation of the window.

In step 424, the CPU 102 runs the processing that corresponds to the instruction selected in step 404. For example, when “Delete” is selected from the menu 304 of FIG. 5, the CPU 102 deletes the icon 302 from the screen 300 and deletes the relevant information from the icon database. When “Change name” is selected from the menu 304 of FIG. 5, the CPU 102 highlights the text of the icon 302 and accepts changes made by the user.

When the operation was not deemed to be an icon operation by the determination result of step 402, the CPU 102 determines in step 426 whether or not the operation is an icon execution order. In concrete terms, when the icon is double-tapped, the CPU 102 determines that it is an order to execute the icon. If it is determined that the operation is an execution order, control shifts to step 420. If not, control shifts to step 428.

In step 428, the CPU 102 determines whether or not the screen operation specified in step 400 is an order to start an application. Shortcut buttons 330 through 334 used to start up various executable applications that have been installed are displayed on the screen 300 (see FIG. 4), and when one of the buttons 330 through 334 is touched, the CPU 102 deems this touch to be an application startup order. If it determines that the operation is an application startup order, control shifts to step 430. If not, control shifts to step 432.

In step 430, the CPU 102 starts the application specified in step 428. Thereafter, control returns to step 400. In step 430, unlike step 420, the application is started up without specifying any file to be the object of the application processing. In addition, because the application is not being executed in a state in which an icon is selected, the CPU 102 displays the window image generated by the application “as is,”—that is, it displays a window such that the upright orientation of the window image coincides with the standard orientation.

In step 432, the CPU 102 determines whether or not the screen operation specified in step 400 is an order to terminate this program. For example, when the OS of the interface device was ordered to terminate, it deems the operation to be a termination order. If it is determined to be a termination order, this program terminates. If not, control shifts to step 434.

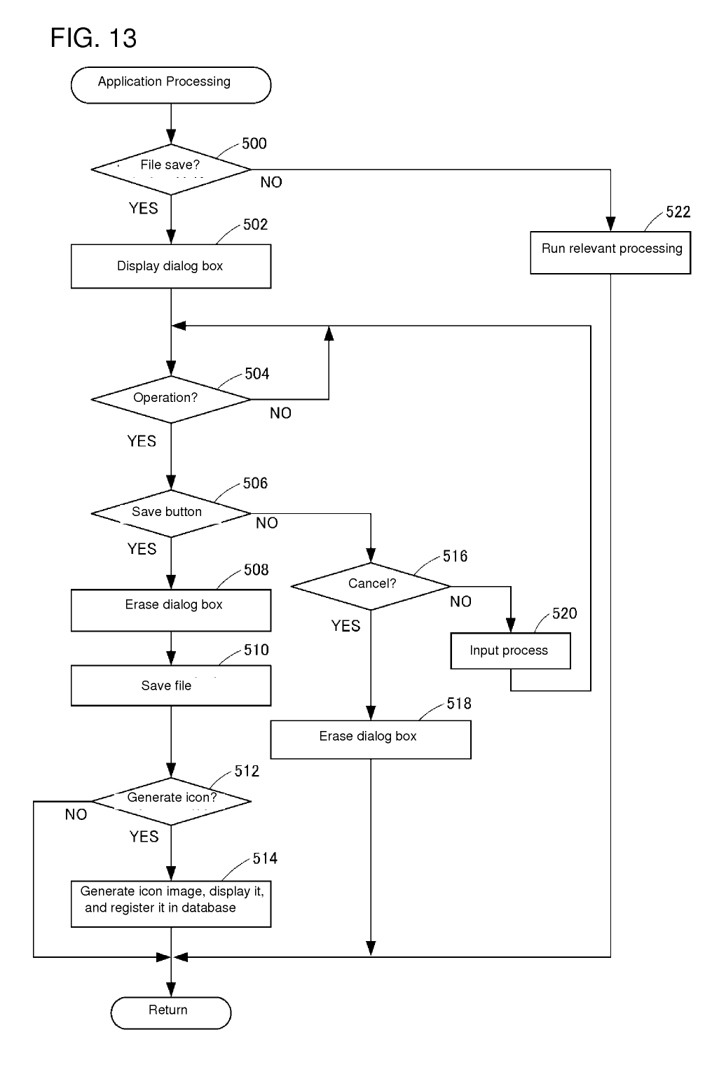

In step 434, processing for the application that is being run, i.e., processing in the case of a touch operation being performed on the displayed window, is performed. FIG. 13 shows the concrete processing of step 434. FIG. 13 primarily shows processing in which an icon is newly generated.

In step 500, the CPU 102 determines whether or not the operation detected in step 400 is a file saving. In concrete terms, when “Save as . . . ,” for example, is touched on the pull-down menu that is displayed as a result of the toolbar within the window being touched, the CPU 102 determines that a file is to be saved. If it has determined that the operation is a file saving, control shifts to step 502. If not, control shifts to step 522.

In step 502, the CPU 102 displays a dialog box (window) for saving files.

In step 504, the CPU 102 determines whether or not an operation involving the dialog box was performed. In concrete terms, the CPU 102 determines whether or not a button displayed in the dialog box was touched or text was input. If it determines that the operation was performed, control shifts to step 506. If not, step 504 is repeated.

As will be described below, the user can input a filename into the text input cell displayed in the dialog box and specify the location (directory) where the file is to be saved. Text can be input, for example, using a keyboard connected to the connecting unit 110. It is also possible to display a software keyboard on the touch panel display and to input text using the displayed software keyboard.

In step 506, the CPU 102 determines whether or not a save button displayed in the dialog box was touched. The save button is an “OK” button, for example. If it determines that a save button was touched, control shifts to step 508. If not, control shifts to step 516.

In step 508, the CPU 102 erases the dialog box displayed.

In step 510, the CPU 102 saves the file in the specified directory of the recording unit 108 under the filename that was input. The CPU 102 uses a publicly known directory hierarchy organization and publicly known file management programs provided by the OS. Note that the filename and the information of the directory where the file is to be saved are input in step 520 (to be described below) and temporarily stored in the RAM 108.

In step 512, the CPU 102 determines whether or not to generate an icon for the file saved in step 510. In concrete terms, the CPU 102 determines whether or not the directory where the file was saved is the prescribed directory. “Prescribed directory” refers to a directory determined in advance to be the one for which files saved in this directory are displayed as icons on the touch panel display. If it is determined that an icon should be generated, control shifts to step 514. If not, control returns to step 400 of FIG. 3.

In step 514, the CPU 102 generates an icon corresponding to the saved file, displays it on the display unit 114, and adds information pertaining to the icon to the icon database. For instance, the icon 302 is displayed as shown in FIG. 4, and the icon information shown in FIG. 6 is added to the icon database. Afterward, control returns to step 400.

In step 516, the CPU 102 determines whether or not a cancel order was received. For example, the CPU 102 determines whether or not a “Cancel” button displayed in a dialog box was touched. If it determines that a “Cancel” button was touched to cancel the operation, control shifts to step 518. If not, control shifts to step 520.

In step 518, the CPU 102 erases the dialog box displayed. Thereafter, control returns to step 400. At this time, the data (filename and the path information to the directory where it was saved) received in the input processing (step 520), described below, are discarded.

In step 520, the CPU 102 performs input processing. For instance, it performs processing that accepts input of the filename to be saved or processing that accepts specification of the directory where the file is to be saved (path information). The received information is temporarily stored in the RAM 106.

Meanwhile, if the operation was not deemed to be a file saving in step 500, the CPU 102 performs, in step 522, the processing that corresponds to the operation detected in step 400. In concrete terms, if an item other than a file saving (such as “New,” “Open,” “Overwrite,” or “Print”) was selected from the toolbar pull-down menu, then the CPU 102 performs the corresponding processing. Afterward, control returns to step 400 (FIG. 3).

With the processes described above, the user is able to create icons (file icons and shortcut icons) on the touch panel display, rotate displayed icons to desired orientations, and display them. When the user has ordered that the prescribed application be run for the icon, a window can be displayed in the same orientation as the specified icon.

When an icon is to be newly generated, the user, for example, touches the button 330 (FIG. 4) to start an application (steps 400 through 430) and then saves the file created by the started application into a prescribed directory (steps 400 through 434 followed by steps 500 through 510). By doing so, a corresponding icon is generated and newly displayed (step 514) on the screen 300 (display unit 114) as shown in FIG. 4.

The user may also double-touch an already displayed file icon 302 (FIG. 4) to start up an application (steps 400 through 426 followed by step 420) and then save it under a different filename in the prescribed directory (steps 400 through 434 followed by steps 500 through 510). In this case, an icon with the different filename is displayed newly on the display unit 114 (step 514).

When a shortcut icon is to be newly generated, the user performs a hold-down operation on the existing icon 302 (FIG. 4), for example, and then touches the “Create shortcut” item on the menu that is displayed (steps 400 through 408). By doing so, the shortcut icon 310 is newly displayed on the screen 300 as shown in FIG. 8.

When rotating the orientation of a displayed icon, the user performs a hold-down operation on the displayed icon, e.g., the icon 310 in FIG. 8, touches the “Rotate” item on the menu that is displayed, and then touches the desired item on the menu that is thereby displayed (steps 400 through 416). When “Rotate left 90°” is touched in FIG. 10, the shortcut icon 312 that rotates the shortcut icon 310 is displayed as shown in FIG. 11.

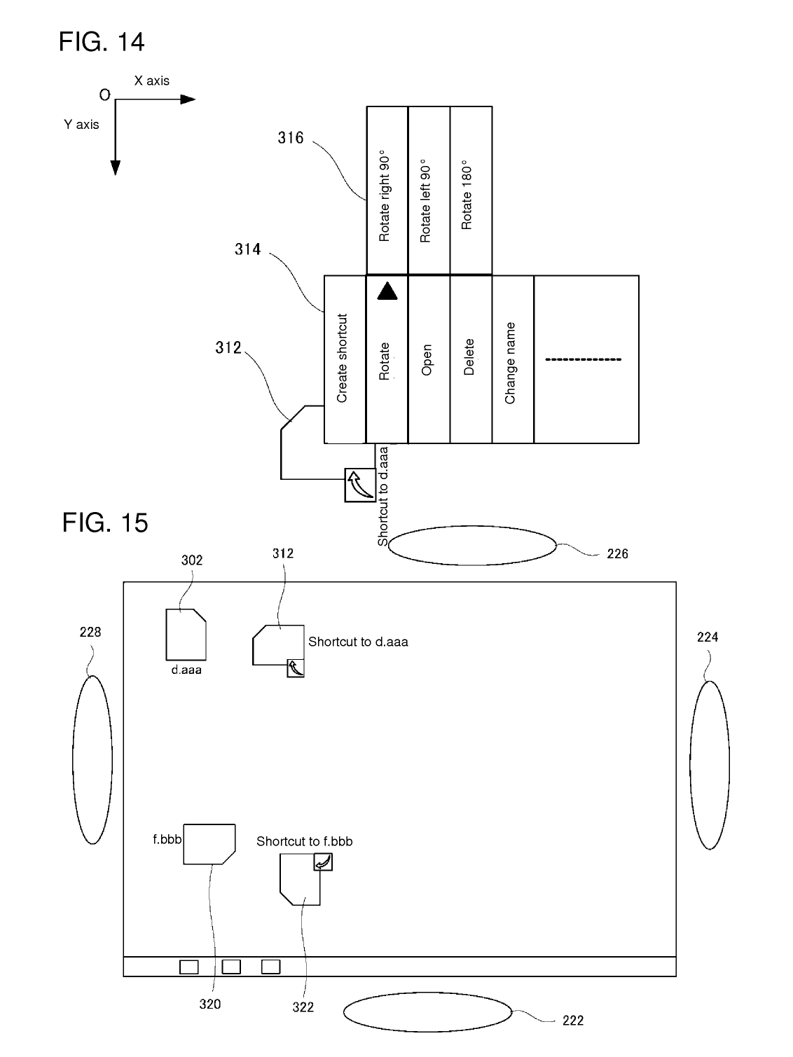

When the user performs a hold-down operation on the shortcut icon 312 in order to rotate the orientation of the shortcut icon 312 shown in FIG. 11, a menu 314 is displayed in the orientation of the icon 312 (the phase “270” of FIG. 12) as shown in FIG. 14. That is, the menu (menu image) is displayed such that the upright orientation of the menu image coincides with the upright orientation of the icon. Furthermore, a menu 316 that is displayed when “Rotate” is touched is displayed in the orientation of the icon 312 (the phase “270” of FIG. 12) as well.

Doing the above enables the user to display the icons 302 and 312 as well as icons 320 and 322 such that the upright orientations of the individual icons become the desired orientations as shown in FIG. 15, for example. The shortcut icon 312 is an icon in which the shortcut generated from the icon 302 is rotated by 90° to the left as described above. The icon 320 is an icon in which the icon created and displayed by saving a file created by an application is rotated by 90° to the right. The icon 322 (whose icon phase is “180”) is an icon created by selecting the icon 320, for example, then generating a shortcut icon facing the standard orientation (with an icon phase of “0”), displaying it, and then rotating the displayed shortcut icon 180°.

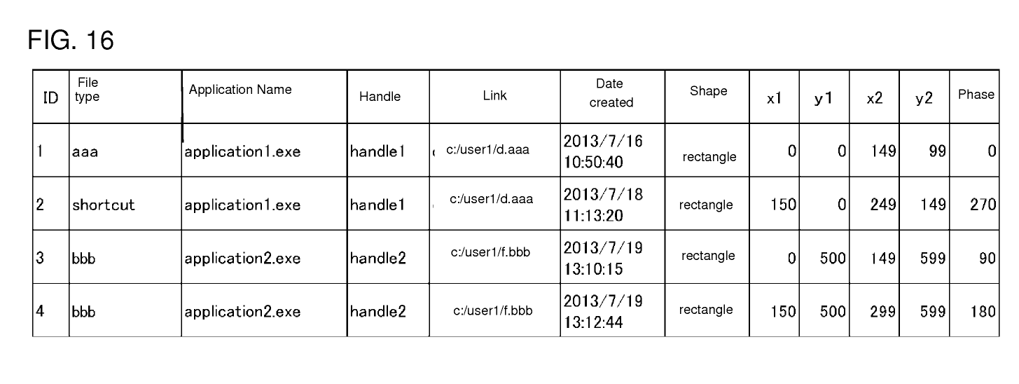

FIG. 16 shows the information of the icon database that corresponds to FIG. 15. All of the icons are the same size; 150 pixels in the X-axis direction and 100 pixels in the Y-axis direction. The phases of the icons 302, 312, 320, and 322 are “0,” “270,” “90,” and “180,” respectively corresponding to the orientations of the individual icons.

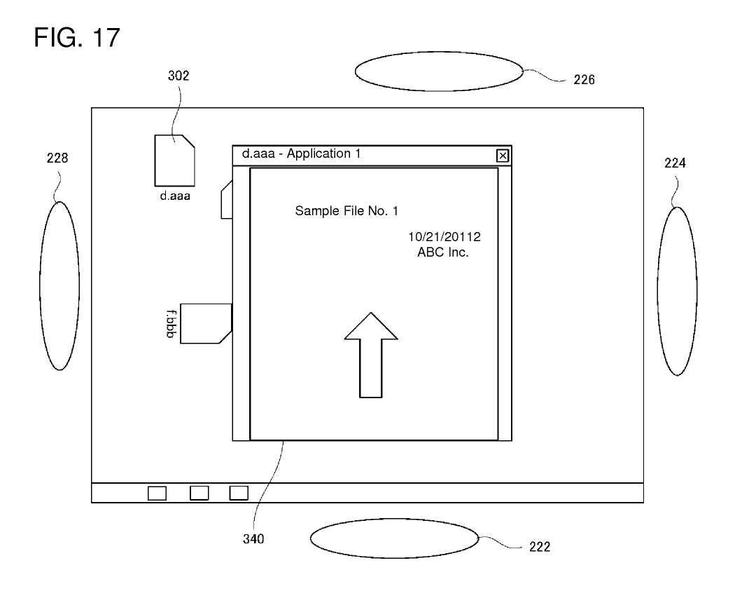

In FIG. 15, when the icon 302 is specified and the corresponding application is run (for example, when the icon 302 is double-tapped), a window 340 is displayed as shown in FIG. 17 by the processing of step 420 and step 422. The upright orientation of the window 340 coincides with the upright orientation of the icon 302. The filename “d.aaa” and the name of the application that created it (“Application 1”) are displayed in the window 340. The window 340 is displayed in an orientation that makes the content it displays more easily legible to the user 222 than to the other three users.

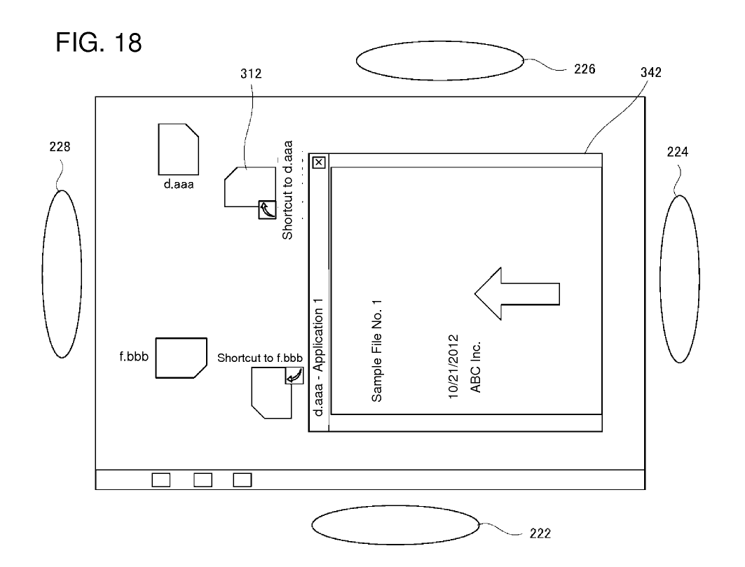

In FIG. 15, when the icon 312 is specified and the corresponding application is run (for example, when the icon 312 is double-tapped), a window 342 is displayed as shown in FIG. 18 by the processing of step 420 and step 422. The upright orientation of the window 342 coincides with the upright orientation of the icon 312. The filename “d.aaa” and the name of the application that created it (“Application 1”) are displayed in the window 342. The window 342 is displayed in an orientation that makes the content it displays more easily legible to the user 224 than to the other three users.

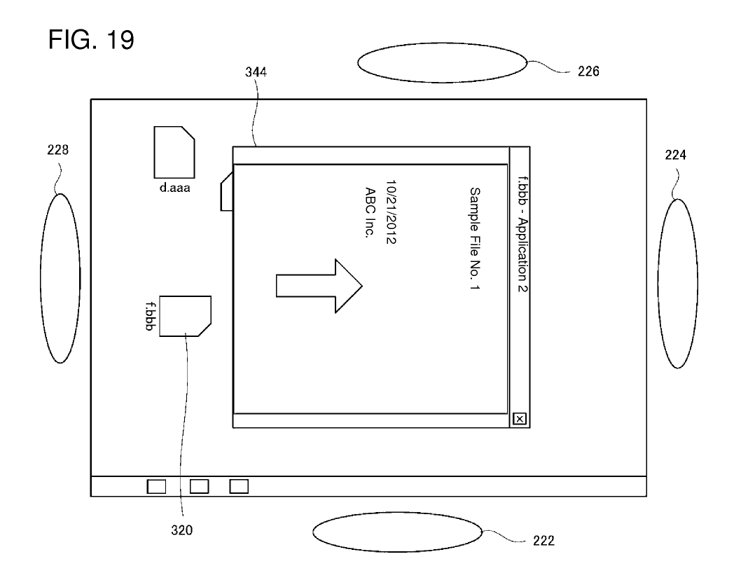

In FIG. 15, when the icon 320 is specified and the corresponding application is run (for example, when the icon 320 is double-tapped), a window 344 is displayed as shown in FIG. 19 by the processing of step 420 and step 422. The upright orientation of the window 344 coincides with the upright orientation of the icon 320. The filename “f.bbb” and the name of the application that created it (“Application 2”) are displayed in the window 344. The window 344 is displayed in an orientation that makes the content it displays more easily legible to the user 228 than to the other three users.

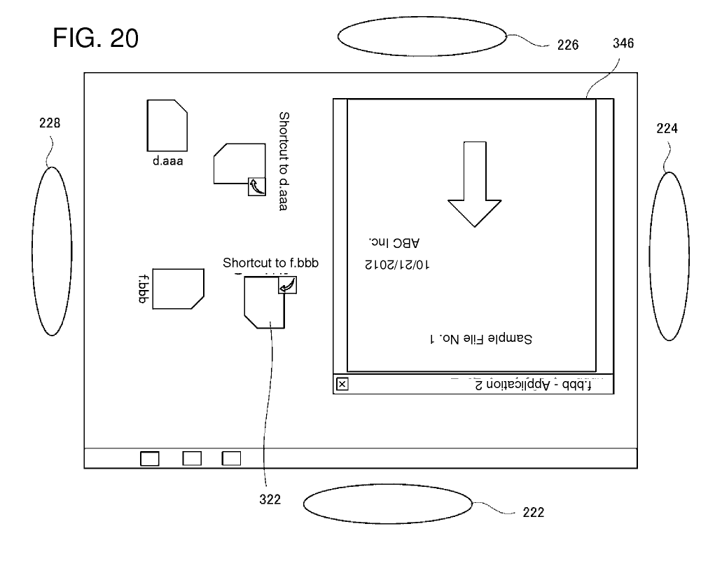

In FIG. 15, when the icon 322 is specified and the corresponding application is run (for example, when the icon 322 is double-tapped), a window 346 is displayed as shown in FIG. 20 by the processing of step 420 and step 422. The upright orientation of the window 346 coincides with the upright orientation of the icon 322. The filename “f.bbb” and the name of the application that created it (“Application 2”) are displayed in the window 346. The window 346 is displayed in an orientation that makes the content it displays more easily legible to the user 226 than to the other three users.

Examples were described above in which, when a shortcut icon is newly generated and displayed in step 408, it is preferably displayed such that the upright orientation thereof coincides with the standard orientation, but the present invention is not limited to this. For instance, when an icon displayed on screen is selected and its shortcut icon is generated, it is also possible to acquire the phase of the selected icon from the icon database and to display the shortcut icon such that the upright orientation thereof matches the acquired phase. For example, when the icon 320 of FIG. 15 (phase of “90”) is selected and the creation of a shortcut icon is ordered, the shortcut icon is displayed such that the upright orientation thereof becomes a rightward orientation (phase of “90”).

Alternatively, the icon orientation may also be made specifiable when an icon is newly created. For instance, when “Create shortcut” is selected on the menu 304 shown in FIG. 5, it is also possible to display the items “No rotation,” “Rotate right 90°,” “Rotate left 90°,” and “Rotate 180°” and to make the orientation of the created shortcut icon selectable, with the orientation of the icon 302 being taken as the reference. If this is done, when a given user, under a circumstance in which a plurality of users are surrounding and viewing a touch panel display, is to create a shortcut icon for an icon that is upright when viewed from his or her own perspective, it is possible, for the benefit of another user who is in a position different from his or her own, to have the shortcut icon displayed so as to be upright when viewed by this another user.

Note that specifying the icon orientation when newly creating a shortcut icon may also be done relative to the standard orientation rather than using the orientation of the selected icon as the reference.

Examples were described above in which a rotation operation preferably is performed for each icon individually, but the present invention is not limited to this. It is also possible to select a plurality of icons and to rotate them simultaneously. For example, in cases where an operation that selects a plurality of icons is followed by a hold-down operation on one of the selected icons, all that is necessary is to display a selection menu in the same manner as in step 404 of FIG. 3, to rotate and display all of the selected icons when “Rotate” is selected, and to update the corresponding information in the icon database in the same manner as in steps 410 through 416.

Examples were described above in which, when an application corresponding to an icon is to be executed, a window preferably is displayed in the same orientation as the orientation of this icon. However, it may also be similarly displayed when another application is to be executed. For instance, it is possible to select an item such as “Open from program” or “Send” on the menu displayed as a result of a hold-down operation being performed on a file icon and then to execute an application other than the application that corresponds to the icon that was held down. In this case as well, a window may be displayed in the same orientation as the orientation of the icon based on the icon phase.

Examples were described above in which a single icon preferably is specified and an application is run, but the present invention is not limited to this. When a plurality of icons are selected and applications are run, the corresponding windows may also be displayed in the orientations of the respective icons. For example, it is possible to design the device such that, if a screen is touched where there is no display of any icon or anything subject to operations, and the touch stops after being dragged (an operation that moves the touched point while maintaining the touch), then all icons in the rectangular area whose opposite vertices are the start point and endpoint of the touched trajectory are placed in the selected state. Accordingly, in cases where an operation that selects a plurality of icons is followed by a hold-down operation on one of the selected icons, for example, all that is necessary is to display a selection menu in the same manner as in step 404 of FIG. 3 and, when “Open” is selected, to determine the orientations of the corresponding windows from the respective phases of the selected icons in the same manner as in steps 418 through 422.

One of the unique features of various preferred embodiments of the present invention is an operation that rotates a displayed icon and when an application is started by specifying an icon, a window is displayed according to the orientation of the icon. Accordingly, the method for generating icons, method for starting applications, and the like may be methods other than those described above. For instance, it is also possible to provide a button that displays a list of installed applications on screen and to execute an application by selecting the application via a touch operation from the list that is displayed when this button is touched. Alternatively, as with the shortcut icon 310, a shortcut icon to specify a default file and start up an application may be displayed on screen.

Examples were described above in which the interface device 100 preferably is equipped with a touch panel display, and instructions are input by touch operations. However, the present invention is not limited to this. Icons may also be manipulated (rotated or the like) using a mouse connected by a cable or wirelessly to the connecting unit 110. Publicly known methods may be used as the method for manipulating icons via mouse operations, for example.

Examples involving a table-style interface device were described above, but the present invention is not limited to this. Any device capable of disposing the display screen horizontally or substantially horizontally, such as a notebook-style personal computer or tablet computer, may be used. If various preferred embodiments of the present invention are applied to such a device, it becomes easier for a plurality of users surrounding the display screen to visually recognize and manipulate icons, windows, and the like that are displayed on the display screen.

### Second Preferred Embodiment

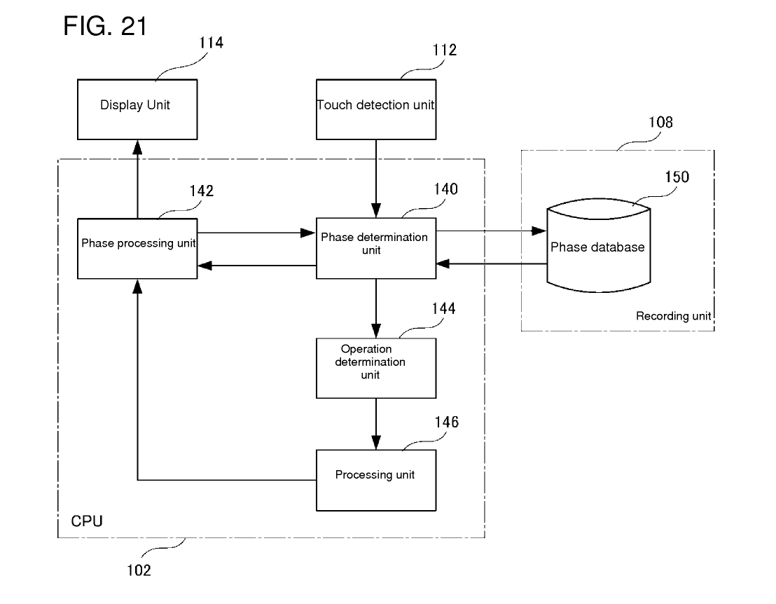

In the first preferred embodiment, the program to rotate icon and window orientations and then to display them preferably was configured as a single program, but in a second preferred embodiment of the present invention, the program is configured to include individual program modules for each function. FIG. 21 is a block diagram showing the functions of the interface device according to the second preferred embodiment as modules for each function. The interface device according to the second preferred embodiment is configured similarly to the interface device 100 (see FIG. 1) according to the first preferred embodiment. Therefore, redundant explanations will not be repeated.

When touched position coordinates are input from the touch detection unit 112 and the fact that the input is a touch operation on an existing icon is detected from the touched points, touched point trajectories, and the like, a phase determination unit 140 acquires the information of the relevant icon from a phase database (which corresponds to the icon database) 150. The phase determination unit 140 outputs the phase data within the acquired icon information to a phase processing unit 142. When an operation that newly creates an icon is detected, the phase determination unit 140 stores new information for the created icon in the phase database 150.

An operation determination unit 144 takes touched position coordinates and icon information from the phase determination unit 140 as input, determines the screen operation based on these, and outputs an order reflecting the determination result to a processing unit 146.

The processing unit 146 uses the functions of the OS or runs applications to generate images (icons, menus, windows, and the like) to be displayed on the display unit 114 according to the orders and icon information that are input from the operation determination unit 144. The processing unit 146 outputs the generated component images (icons, menus, windows, and the like) to the phase processing unit 142.

The phase processing unit 142 rotates the orientation of a component image that is input from the processing unit 146 according to the phase data that is input from the phase determination unit 140 and outputs it to the display unit 114. In concrete terms, when the phase processing unit 142 generates an image in which the orientation of the input image is rotated and stores it in the VRAM 118 shown in FIG. 1, the display control unit 116 is used to display this image on the display unit 114.

For example, when a hold-down operation on a displayed icon is detected, the phase determination unit 140 acquires the information of the relevant icon from the phase database 150 and outputs the phase from this information to the phase processing unit 142. Moreover, the operation determination unit 144 outputs an order to display a menu to the processing unit 146; when the processing unit 146 receives it, it generates a conventional menu image (whose upright orientation coincides with the standard orientation) and outputs it to the phase processing unit 142. The phase processing unit 142 rotates the menu image that is input from the processing unit 146 according to the phase data that is input from the phase determination unit 140 and outputs it to the display unit 114. Consequently, the menu is displayed in the same orientation as the orientation of the icon on which the hold-down operation was performed (see FIG. 5).

When it is detected that the “Rotate” item of the displayed menu was selected by touch, the angle selection menu 306 (see FIG. 10) is displayed in the same manner as described above.

In addition, when it is detected that an item of the displayed angle selection menu 306 was selected by touch, the phase determination unit 140 changes the icon information acquired from the phase database 150 according to the angle that corresponds to the selected menu item. The phase is changed by the angle that corresponds to the selected menu item and is output to the phase processing unit 142. The phase determination unit 140 updates the relevant icon information with the changed icon information (see FIG. 12, which shows an example in which “Rotate left 90°” is selected). The phase processing unit 142 rotates the icon image that is input from the processing unit 146 according to the changed phase that is input from the phase determination unit 140 and outputs it to the display unit 114. As a result, the held-down icon is displayed after being rotated according to the selected angle selection menu item (see FIG. 11).

When it is detected that the “Create” item on the displayed menu was touched, the phase determination unit 140 determines the ID of the shortcut icon to be newly created such that it does not duplicate any ID stored in the icon database, and links part of the existing icon information acquired from the phase database 150 (the application name, handle, link, phase, and the like of FIG. 9) to the determined ID, and stores it in the icon database. Preset data corresponding to the shortcut icon is stored for the file type, shape, (x1, y1) and (x2, y2). However, (x1, y1) and (x2, y2) are stored as shifted values so as not to overlap the original icon. Furthermore, the phase determination unit 140 outputs the phase of the original icon information to the phase processing unit 142. Moreover, the operation determination unit 144 outputs an order to generate a shortcut icon to the processing unit 146; when the processing unit 146 receives it, it generates a conventional shortcut icon image (whose upright orientation coincides with the standard orientation) and outputs it to the phase processing unit 142. The phase processing unit 142 rotates the shortcut icon image that is input from the processing unit 146 according to the phase data that is input from the phase determination unit 140 and outputs it to the display unit 114. Consequently, the shortcut icon is displayed in the same orientation as the orientation of the icon on which the hold-down operation was performed (see FIG. 8).

In addition, when it is detected that a displayed icon was specified and application execution was ordered (the icon was double-tapped), for example, the phase determination unit 140 acquires the information of the relevant icon from the phase database 150 and outputs the phase from this information to the phase processing unit 142. Furthermore, the operation determination unit 144 outputs a link contained in the icon information (input from the phase determination unit 140) and an order to execute an application to the processing unit 146; when the processing unit 146 receives them, it starts the application and uses the file identified by the link to generate a conventional window image (whose upright orientation coincides with the standard orientation) and outputs it to the phase processing unit 142. The phase processing unit 142 rotates the window image that is input from the processing unit 146 according to the phase data that is input from the phase determination unit 140 and outputs it to the display unit 114. As a result, the window is displayed in the same orientation as the orientation of the double-tapped icon (see FIGS. 17 through 20).

Thus, in the second preferred embodiment as well, just as in the first preferred embodiment, icons are capable of being rotated and then displayed, so when an icon is selected and processing is ordered, menus and windows are displayed in the same orientation as the orientation of the selected icon.

### Third Preferred Embodiment

A method in which the angle that the icon is to be rotated is selected from a menu was used in the first and second preferred embodiments, but a different icon rotation method will be used in a third preferred embodiment of the present invention. The interface device according to the third preferred embodiment is configured similarly to the interface device 100 (see FIG. 1) according to the first preferred embodiment and runs a program similar to FIG. 3. Therefore, redundant explanations will not be repeated.

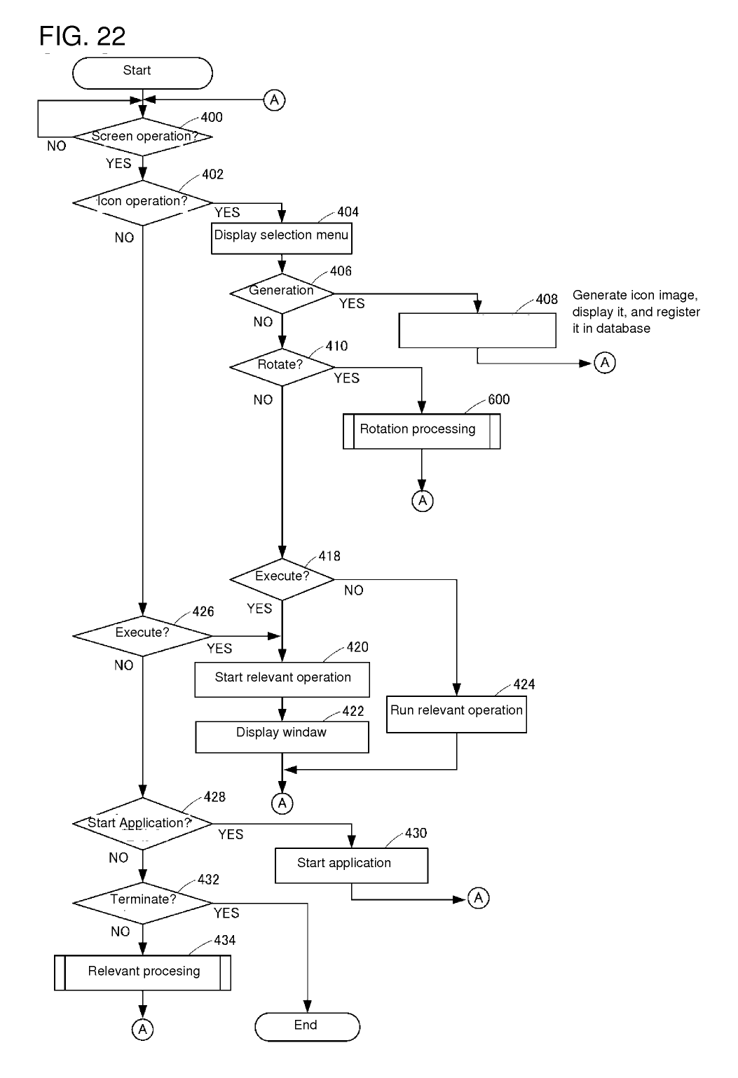

FIG. 22 shows the control structure of the program that is run in the third preferred embodiment. The only difference from FIG. 3 is that the steps 412 through 416 of FIG. 3 are replaced by step 600.

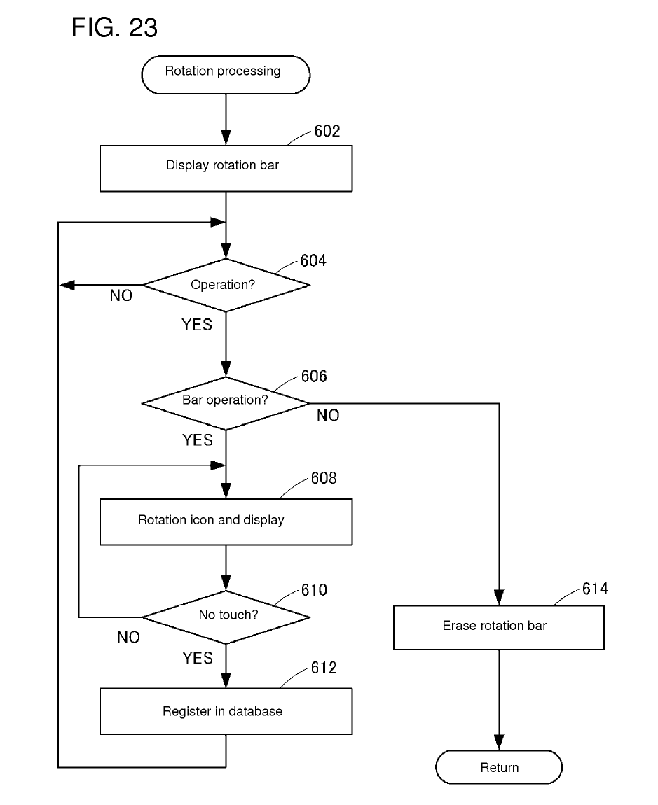

When it was determined in step 410 that an order to rotate the icon orientation was selected (for example, when it was determined that “Rotate” was touched in the menu 304 shown in FIG. 5), processing to rotate the icon orientation is executed in step 600. FIG. 23 shows the rotation processing of step 600.

In step 602, the CPU 102 displays a rotation bar (component image) so as to be superimposed on the icon and then awaits an operation. The rotation bar is displayed such that the direction of length of the rotation bar coincides with the standard orientation, for example. As will be described below, the user can specify the angle of icon rotation by touching and dragging the rotation bar.

In step 604, the CPU 102 determines whether or not a touch operation involving the touch detection unit 112 was performed. In concrete terms, the CPU 102 determines whether or not position coordinates were received from the touch detection unit 112. If it determines that position coordinates were received, i.e., a touch operation was deemed to be performed, control shifts to step 606. If not, step 604 is repeated.

In step 606, the CPU 102 determines whether or not the operation is a touch operation on the rotation bar. In concrete terms, the CPU 102 determines whether or not the position coordinates received in step 604 are position coordinates on the image of the rotation bar. If the received position coordinates are position coordinates on the image of the rotation bar, i.e., a touch operation was deemed to be performed on the rotation bar, control shifts to step 608. If not, i.e., if it is determined that an area other than the rotation bar was touched, control shifts to step 610.

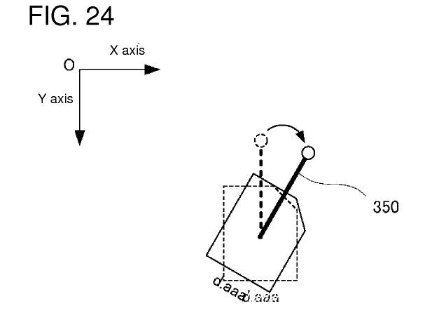

In step 608, the CPU 102 rotates and displays the icon according to the drag operation that was performed. In concrete terms, the CPU 102 calculates the rotation direction and rotation angle from the trajectory of the drag operation, uses its calculated values to generate the images of the rotated icon and the rotation bar, and stores them in the VRAM 118. At this time, the CPU 102 calculates the rotation angle from the standard orientation (for example, a clockwise rotation angle) in the prescribed angle units (for example, in units of about)1° and overwrites them in the RAM 106. As a result, the rotated icon is displayed on the display unit 114, and the latest angle is maintained. For example, as shown in FIG. 24, if the icon is placed in a state as indicated by the dotted line, and the user touches a rotation bar 350 and drags it in a rightward rotation as indicated by the arrow, then the icon and the rotation bar that have been rotated as indicated by the solid line are displayed.

In step 610, the CPU 102 determines whether or not the touch is no longer being maintained on the rotation bar. In concrete terms, when position coordinates are not received from the touch detection unit 112 for at least a prescribed period of time, the CPU 102 determines that the touch is no longer being maintained. If it determines that the touch is no longer being maintained, control shifts to step 612. If not, control shifts to step 608. Step 608 is repeated if the touch is held and dragged in step 608 and step 610, so it is possible to display the icon during the rotation operation.

When touch is no longer maintained, the CPU 102 reads the current icon rotation angle from the RAM 106 and updates the phase of the corresponding icon in the icon database in step 612. Note that the icon database includes the icon size (the number of vertical pixels and the number of horizontal pixels) and the position coordinates of the center of icon rotation instead of (x1, y1) and (x2, y2), and these position coordinates do not change. Afterward, control shifts to step 604. Because of this, even when a drag operation is temporarily stopped, the rotated icon and rotation bar will remain displayed, so the user can repeat rotation bar drag operations and further rotate the icon.

If the operation was deemed not to be a rotation bar operation in step 606, the CPU 102 erases the displayed rotation bar in step 610. Thereafter, control returns to step 400 of FIG. 22. Accordingly, the user can erase the rotation bar and terminate icon rotation operations by touching an area outside of the rotation bar.

Thus, in the third preferred embodiment, unlike the first preferred embodiment, the user can set the upright orientation of the icon (the icon phase) to any orientation in the prescribed angle units (for example, units of about 1°). When an icon is selected and an application is run, the icon phase is read from the icon database in step 422 (FIG. 22), and the window is displayed such that the upright orientation of the window coincides with the upright orientation of the icon. This makes it possible to display a window in the same orientation as the selected icon. Consequently, icons and windows can be displayed such that they can be seen as upright when viewed by users other than the user positioned near the center of the sides of a rectangular touch panel display, such as users positioned near the corners of a rectangular touch panel display.

An example was described above in which a component image for rotation (a rotation bar) preferably is displayed so as to be superimposed over an icon, but the present invention is not limited to this. Icons may also be operated by direct touch without displaying a component image for rotation. For instance, in a state in which an icon is selected by touch, the rotation angle may be determined in the same manner as described above when two points near the icon are touched simultaneously and the two points, while being touched, are then rotated around the icon.

An example was described above in which the angle of the icon rotated on screen is stored “as is” in the icon database as the icon phase, but the present invention is not limited to this. Icons being rotated are displayed as they are rotated according to the drag, but the icon orientation (phase) that is ultimately defined may be limited to up, down, left, and right orientations. For example, if the rotation angle α determined by the user's drag operation is such that 45≦α≦135, then phase θ=90; if 135≦α≦225, then phase θ=180; if 225≦α≦315, then phase θ=270; and if 0≦α≦45 or 275≦α≦0, then phase θ=0.

The present invention was described above by describing preferred embodiments, but the preferred embodiments described above constitute merely illustrative examples, and the present invention is in no way limited to the above-described preferred embodiments and can be carried out with a variety of modifications.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An interface device including:
a display device configured to display icons on a screen; and
a processor configured and programmed to define:
a rotating unit configured to order changes in orientations of the icons;
an executing unit configured to select at least one of the icons and order execution of an application program;
a changing and displaying unit configured to change the orientations of the icons and display the changed orientations of the icons in response to the rotating unit ordering the changes in the orientations of the icons; and
a displaying unit configured to, upon accepting that the executing unit has selected the at least one of the icons and ordered execution of the application program, display a window such that an orientation of the window coincides with the orientation of the at least one of the icons.

2. The interface device according to claim 1, further comprising a storage device configured to store phase information that indicates the orientations of the icons relative to a standard orientation set for the screen, the storage device being configured to change the phase information of the icons in response to the rotating unit ordering the changes in the orientations of the icons, and upon accepting that the executing unit has selected the at least one of the icons and ordered execution of the application program, the display device displays the window in an orientation determined by the phase information of the at least one of the icons.

3. The interface device according to claim 1, wherein the rotating unit is configured to change the orientation of each of the icons to an arbitrary orientation.

4. The interface device according to claim 1, wherein the orientation of each of the icons is any of four orientations that face four sides of the screen from a center of each of the icons.

5. The interface device according to claim 1, wherein, upon accepting that the executing unit has selected a plurality of the icons and ordered execution of a plurality of the application programs, the display device displays corresponding windows such that the orientations of the windows coincide with the respective orientations of the selected icons.

6. An interface method comprising the steps of:
displaying icons on a screen;
ordering changes in orientations of the icons; and
selecting at least one of the icons;
ordering execution of an application program;
changing the orientations and displaying the changes in the orientations of the icons in response to the step of ordering changes in orientations of the icons; and
after the steps of selecting at least one of the icons and ordering execution of an application program, displaying a window such that an orientation of the window coincides with the orientation of the at least one of the icons selected in the step of selecting at least one of the icons.

7. A non-transitory computer-readable medium including a computer program for having a computer equipped with a display device perform, when the computer program runs on the computer, a method comprising the steps of:
displaying icons on a screen of the display device;
ordering changes in orientations of the icons;
selecting at least one of the icons;
ordering execution of an application program;
changing the orientations and displaying the changes in the orientations of the icons in response to the step of ordering changes in orientations of the icons; and
after the steps of selecting at least one of the icons and ordering execution of an application program, displaying a window such that an orientation of the window coincides with the orientation of the at least one of the icons selected in the step of selecting at least one of the icons.
